(19) United States
(12) Patent Application Publication
(10) Pub. No.: US 2022/0374945 A1
(43) Pub. Date: Nov. 24, 2022

(54) Method for Managing Item Feed Information and an Apparatus for the Same

(71) Applicant: Coupang Corp., Seoul (KR)

(72) Inventors: Jae Hee Lee, Seoul (KR); Jae Sic Hwang, Seoul (KR); Chang Kwon Jeong, Seoul (KR); Qiang Sun, Seoul (KR); Sang Jun Kim, Seoul (KR); Binna Kim, Seoul (KR); Hyun Jung Cho, Seoul (KR)

(73) Assignee: Coupang Corp., Seoul (KR)

(21) Appl. No.: 17/458,738

(22) Filed: Aug. 27, 2021

(30) Foreign Application Priority Data
May 21, 2021 (KR) 10-2021-0065472

(51) Int. Cl. G06Q 30/02

(52) U.S. Cl. CPC G06Q 30/0277; G06Q 30/0273; G06Q 30/0264

(57) ABSTRACT

A method for managing item feed information according to example embodiments may include at least one of generating source information for an advertisement feed of items based on item information of a service related to the electronic apparatus, acquiring setting information for feed generation, generating feed information corresponding to at least one publisher by processing the generated source information based on the setting information, and providing the generated feed information to a server of the at least one publisher.

### RELATED APPLICATION INFORMATION

The present application claims priority to and the benefit of Korean Patent Application No. 10-2021-0065472 filed on May 21, 2021, and is incorporated by reference herein in its entirety.

### TECHNICAL FIELD

The present disclosure relates to a method and an apparatus for managing item feed information and, more specifically, to a method and an apparatus for managing item feed information for efficiently managing and providing an advertisement feed of an item provided to a publisher to advertise the item.

### DESCRIPTION OF THE RELATED ART

The advertisement may include, for example, various types of advertisements, such as display advertisements, affiliate advertisements, keyword advertisements, and the like. For example, in keyword advertisements, an advertiser (or an advertising agency) registers a keyword that can advertise their website, company, or product on a search engine site, and, when a general user who wants to search enters a search word in a search word input box and a search is performed, an advertisement of the advertiser who has purchased the keyword corresponding to the search word is exposed as a search result.
Prior documentation: Korean Patent Registration No. 10-1703919

### DISCLOSURE OF THE INVENTION

### Technical Goals

An aspect of the present disclosure is to provide a method and an apparatus for managing item feed information to solve the above issues.

### Technical Solutions

According to an aspect, there is provided a method for managing item feed information including generating source information for an advertisement feed of items based on item information of a service related to an electronic apparatus, acquiring setting information for feed generation, generating feed information corresponding to at least one publisher by processing the generated source information based on the setting information, and providing the generated feed information to a server of the at least one publisher.

The setting information according to example embodiments may include first information for processing title information included in the source information, and the generating of the feed information may include generating the feed information by processing the title information based on the first information.

In addition, the first information may include information on a phrase added to the title information, the generating of the feed information may include appending the phrase to the title information, and the information on the phrase may be determined based on the information on the item and the at least one publisher.

Further, the setting information according to example embodiments may include second information indicating a method of displaying price information included in the source information, and the generating of the feed information may include processing the price information of the item based on the second information.

In addition, the setting information according to example embodiments may include third information indicating time information for providing the generated feed information to the publisher, and the providing to the server may provide the feed information to the at least one publisher based on the third information.

Further, the setting information according to example embodiments may include fourth information indicating a landing address of a page corresponding to an item accessible through the generated feed information, and the method for managing item feed information may further include providing a page corresponding to the item based on the landing address when a request corresponding to the landing address is received.

Further, the fourth information according to example embodiments may include item identification information for identifying the item and vendor identification information for identifying a vendor for the item.

Further, the setting information according to example embodiments may include fifth information indicating a category of the item and sixth information indicating a search tag for searching for the item.

In addition, the setting information according to example embodiments may be set differently according to a policy for feed information applied to each item.

In addition, the generating of the feed information according to example embodiments may include checking the setting information corresponding to the policy applied to each item, and generating the feed information for the one or more items based on the setting information corresponding to the policy.

Further, the setting information according to example embodiments may be set differently for each publisher.

In addition, the providing according to example embodiments may include uploading the generated feed information to an external server providing to the at least one publisher based on a syndication request of the at least one publisher.

Furthermore, the method for managing item feed information according to example embodiments may further include storing the generated feed information, and the providing may provide the stored feed information to the at least one publisher based on a syndication request of the at least one publisher.

Furthermore, the method for managing item feed information according to example embodiments may further include providing a page indicating a status of providing the feed information to the at least one publisher.

In addition, the setting information according to example embodiments may further include seventh information indicating a file format of the feed information.

Furthermore, the fourth information according to example embodiments may be set differently for each operating system of a client.

### Effects

When providing advertisement information about an item to an external publisher, the electronic apparatus according to example embodiments uses a filter corresponding to the publisher for necessary information among the information of the item in a service operated by the electronic apparatus to create a feed according to the characteristics of the publisher. Therefore, it is possible to adaptively perform advertisements according to the characteristics of the publisher, thereby increasing the advertisement effect and effectively managing information on items provided in the advertisements.

The electronic apparatus according to example embodiments updates information on the item and provides the feed by using a separate storage in the process of collecting the information on the item, configuring data, generating the feed, and processing the feed, thereby simplifying the process of providing the publisher with the advertisement feed for the item and reducing unnecessary delay and memory burden.

The electronic apparatus according to example embodiments continuously receives and updates the information on the item and, at the same time, provides advertisement feed information to the publisher at regular intervals to include and transmit the updated information on the item in the advertisement feed without unnecessary delay.

By setting parameters for configuring the advertisement feed, the electronic apparatus according to example embodiments may automatically update the information on the item based on the set parameters, thereby reducing system delay and assisting the administrator to create a customized advertisement feed.

### BRIEF DESCRIPTION OF THE DRAWINGS

FIG. 1 illustrates an example of internal components of an electronic apparatus according to example embodiments.

FIG. 2 is a configuration diagram illustrating an example of a feed management apparatus according to example embodiments.

FIG. 3 illustrates an item feed information management system according to example embodiments.

FIG. 4 is a diagram illustrating an example of a method for a feed management apparatus to filter items according to example embodiments.

FIG. 5 is a diagram illustrating an example of a method for a feed management apparatus according to example embodiments to provide an advertisement feed to a publisher by generating or processing the advertisement feed.

FIG. 6 shows an example of setting information related to an advertisement feed of an item according to example embodiments.

FIG. 7A and FIG. 7B show examples of setting information related to an advertisement feed of an item according to example embodiments.

FIG. 8 illustrates an example of a first page for setting, by an electronic apparatus according to example embodiments, setting information related to an advertisement feed of an item in order to configure the advertisement feed of the item.

FIG. 9 illustrates an example of a first page for setting, by an electronic apparatus according to example embodiments, setting information related to an advertisement feed of an item in order to configure the advertisement feed of the item.

FIG. 10 illustrates a second page indicating a status in which an electronic apparatus according to example embodiments provides an advertisement feed of an item to a publisher.

FIG. 11 shows an example of a method for managing item feed information of an item according to example embodiments.

### DETAILED DESCRIPTION FOR CARRYING OUT THE INVENTION

Hereinafter, example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

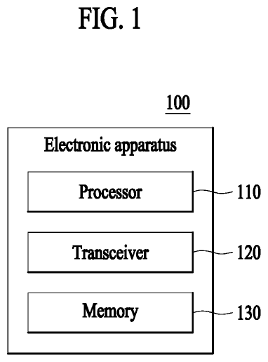

FIG. 1 illustrates examples of internal components of an electronic apparatus according to example embodiments.

Referring to FIG. 1, internal components of an electronic apparatus 100 are not limited to those illustrated. The electronic apparatus 100 may include at least one of a processor 110, a transceiver 120, and a memory 130.

The processor 110 may process a series of operations for performing a method for managing item feed information according to various example embodiments of the present disclosure. The processor 110 may control other components of the electronic apparatus 100. Meanwhile, in an example embodiment, a product may be used as a term referring to a specific item, and the item may be sold to a user in a service related to the electronic apparatus 100.

The processor 110 may check detailed information about a first product in response to a request of a first page for the first product. The processor 110 executes at least one program, and the method for managing item feed information according to example embodiments may generate source information for an advertisement feed of items based on item information of a service related to the electronic apparatus, acquire setting information for feed generation, generate feed information corresponding to at least one publisher by processing the generated source information based on the setting information, and provide the generated feed information to a server of the at least one publisher. The program or computer readable instructions executed by the processor 110 may be previously stored in the memory 130 or received from the outside through the transceiver 120. The processor 110 may provide a first page to a display of the electronic apparatus 100.

The transceiver 120 may perform functions of transmitting information stored in the memory 130 of the electronic apparatus 100 or information processed by the processor 110 to another apparatus or receiving information from another apparatus to the electronic apparatus 100.

The memory 130 is a configuration implemented in a predetermined storage space of the electronic apparatus 100, which may include a database that functions such as storing, searching, deleting, editing, or adding data may be freely performed. For example, the memory 130 may have fields or elements for processing functions such as storing, searching, deleting, editing, or adding data. The memory 130 may store data related to performing item feed information management method by the electronic apparatus 100. For example, the memory 130 may store instructions or data for an execution operation of the processor 110. The memory 130 according to example embodiments may include a database for storing information on an item, and so on.

The electronic apparatus 100 according to example embodiments may perform the item feed information management method according to example embodiments described below. The electronic apparatus 100 may be referred to as, for example, an item feed information management apparatus.

In addition, an interface described in this specification may be interpreted in various ways such as a configuration of hardware for receiving an input signal from a user, or an icon, widget, button, slide bar, progress bar, touch area, widget that accepts text input (e.g., text area, etc.), check box, and the like implemented in software. In addition, advertisements described below may include various types of advertisements, such as display advertisements, affiliate advertisements, keyword advertisements, and the like.

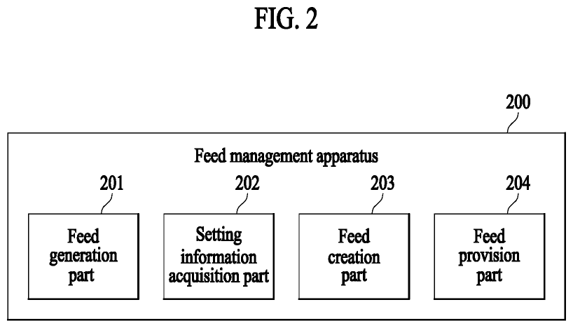

FIG. 2 is a configuration diagram illustrating an example of a feed management apparatus 200 according to example embodiments.

The feed management apparatus 200 according to example embodiments shown in FIG. 2 may refer to the electronic apparatus 100 of FIG. 1. Some or all of the configurations of the feed management apparatus 200 according to example embodiments shown in FIG. 2 may be configured with at least one of the processor 110, the transceiver 120, and the memory 130 of FIG. 1 or a combination thereof. Hereinafter, the feed management apparatus 200 according to example embodiments may be referred to as an electronic apparatus 200 according to example embodiments.

The electronic apparatus 200 according to example embodiments may include at least one of a feed generation part 201, a setting information acquisition part 202, a feed creation part 203, and a feed provision part 204.

The feed generation part 201 may generate source information for an advertisement feed of an item based on item information of a service related to the electronic apparatus. The item information may include, for example, information on an item to be advertised by the electronic apparatus according to example embodiments. The item information may include, for example, a name of the item, a price of the item, information about a vendor indicating a company that supplies the item (e.g., a vendor identifier for identifying the vendor of the item, etc.), an item identifier identifying the item, and a category of the item.

The source information according to example embodiments may be referred to as, for example, snapshot information.

The feed generation part 201 may extract the item information and generate source information (snapshot information) for generating an advertisement (e.g., a banner advertisement, etc.) for the item. The source information may include, for example, information necessary for generating a feed advertising the item to be advertised. The feed may refer to, for example, data or data format used to provide users or buyers with advertising contents (e.g., contents used to advertise the item) updated frequently. As an example, the feed may include the information on the item provided to an external publisher, and the external publisher may receive the feed information and provide an advertisement for the item corresponding to the feed information on its own platform based on this. In an example embodiment, the advertisement may be performed in the form of providing a search result using at least a portion of the feed information or providing in the form of a banner.

The source information (snapshot information) may include, for example, detailed information about the item provided for advertisement. The source information may include, for example, for each item, information about a file including information on the item, information for identifying the item or the file including information on the item, information indicating whether the file including information on the item is useful, a date when the information on the item was last modified, item identification information for identifying the item, information indicating a price of the item, information indicating how the price of the item is discounted, information for identifying a vendor for the item, and information indicating a score calculated for the item. The source information (snapshot information) may further include, for example, a name of each item, a price of the item, information indicating reviews of buyers or users of the item, thumbnail information about the item (e.g., a representative image of the item, etc.), information indicating an image or video representing the item, origin information of the item, and information indicating a detailed description of the item.

The source information (snapshot information) may be configured or generated, for example, in a JavaScript Object Notation (JSON) format, and the generated source information may be stored in a storage part included in an electronic apparatus according to example embodiments. Meanwhile, the source information may be in the form of a file extracted from a database and statically recorded for providing item information in a service provided by the electronic apparatus. In this way, it is possible to minimize access to the database for feed generation by statically recording a file and generating a feed based on it.

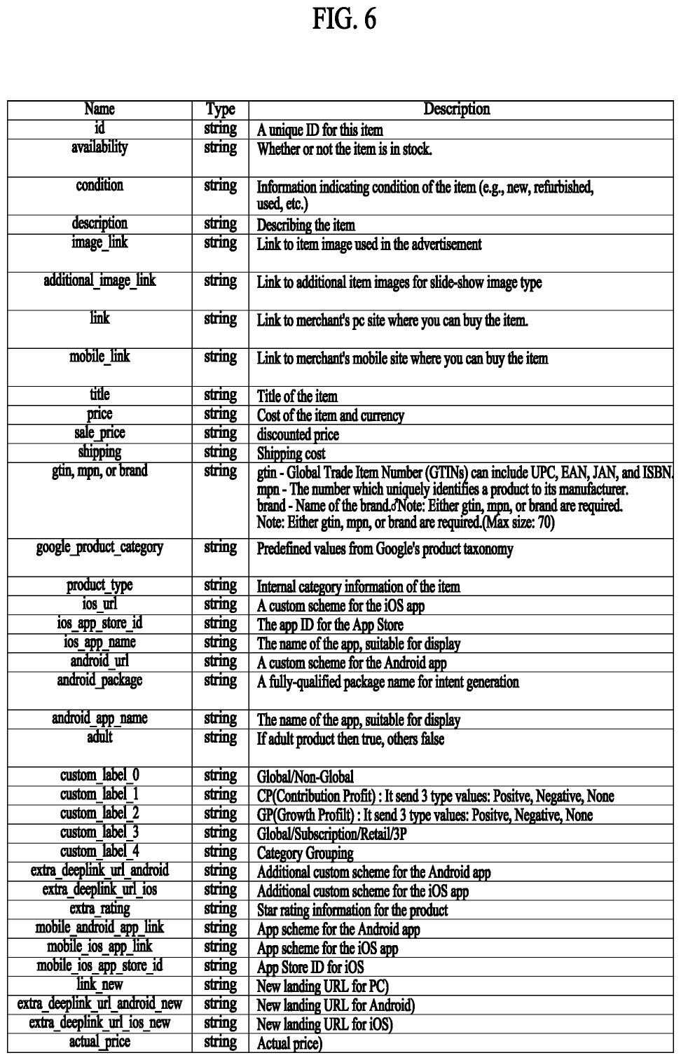

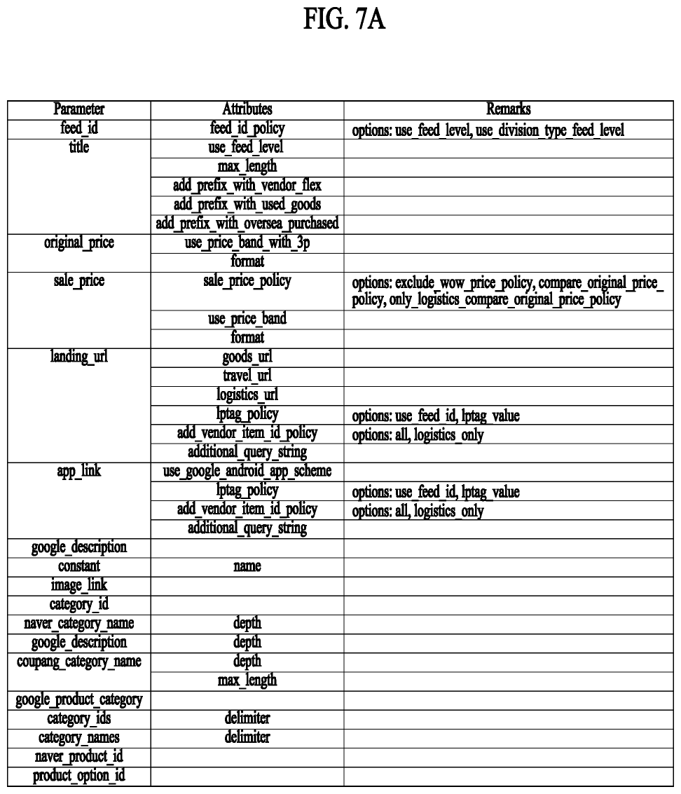

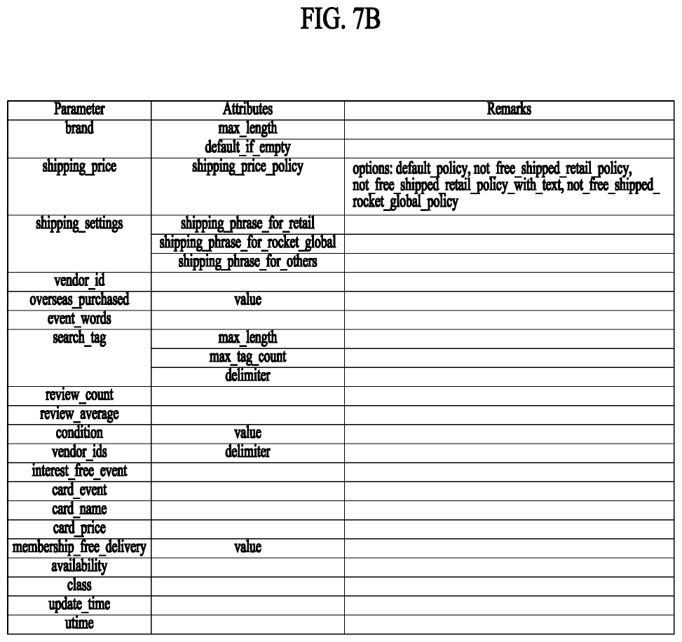

The setting information acquisition part 202 may acquire setting information necessary for the electronic apparatus according to example embodiments to generate an advertisement feed adapted to a publisher. The setting information may be set by an input signal received from an administrator, or may be set by the system. The setting information may include information necessary for generating the advertisement feed for all items or for a specific item. In order to generate the advertisement feed, the feed may be generated by processing the source information based on the setting information, and this process of processing the source information may be referred to as a filtering operation. The setting information according to example embodiments will be described in detail with reference to FIGS. 6, 7A and 7B.

The setting information according to example embodiments may be set differently for each publisher, and may be set differently for each item or for each item group including one or more items.

The setting information according to example embodiments may include information about a policy. The policy according to example embodiments may refer to a criterion by which the electronic apparatus according to example embodiments selects one or more specific item(s) from among a plurality of items. That is, the electronic apparatus according to example embodiments may identify one or more items to which a specific policy is applied, and may process feed information for the corresponding items based on the setting information corresponding to the specific policy. That is, the electronic apparatus according to example embodiments may generate feed information for one or more items based on the setting information corresponding to the policy. That is, the electronic apparatus may check the setting information according to example embodiments corresponding to the item(s) corresponding to a specific policy, and generate an advertisement feed by applying the checked setting information to the item(s).

For example, the setting information acquisition part 202 may acquire, from an administrator, at least one of information on a publisher who will provide the advertisement feed, item(s) subject to the advertisement feed or policy(s) for specifying the item, and detailed setting information applied to corresponding item(s). The setting information acquisition part 202 may store the acquired information, and may transmit the acquired information to the feed creation part 203.

The feed creation part 203 may generate feed information corresponding to at least one publisher by processing the generated source information based on the setting information. That is, the feed creation part 203 processes the feed information of the item to be advertised. The feed creation part 203 processes the feed information of the item based on the setting information corresponding to the item. That is, the feed creation part 203 may receive and store the setting information set by the administrator or set by the system from the setting information acquisition part 202 according to example embodiments, and use the received or stored setting information to process (or update) the feed information for each item to suit the publisher.

The feed provision part 204 may provide the publisher with the feed information processed or updated by the feed creation part 203. The feed provision part 204 may provide the feed information to the publisher by, for example, uploading the feed information to an external server configured to provide the feed information to the publisher based on a syndication request of the publisher.

The electronic apparatus may store the feed information generated or processed by the feed creation part 203 in a storage part (or a storage space for storing the processed feed information, etc.). In this case, the feed provision part 204 may extract and check the stored feed information from the storage part in response to the publisher's syndication request, and provide it to the publisher.

The electronic apparatus according to example embodiments provides the feed to the server corresponding to the publisher by periodically updating the information on the item, thereby simplifying a procedure for providing the advertisement feed for the item to the publisher and reducing unnecessary time delay and memory load.

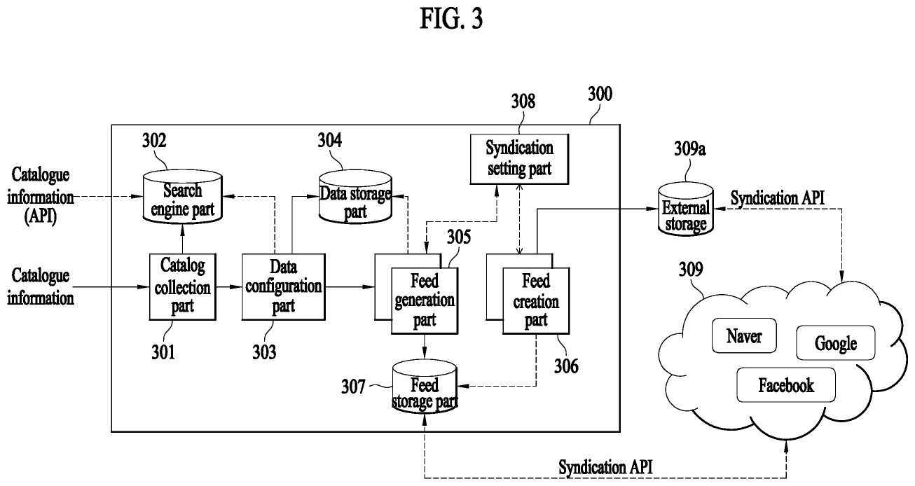

FIG. 3 illustrates a feed management apparatus according to example embodiments and an example operation thereof.

The feed management apparatus 300 according to example embodiments shown in FIG. 3 may correspond to the electronic apparatus 100 of FIG. 1 and the feed management apparatus 200 of FIG. 2. Some or all of the configurations of the feed management apparatus according to example embodiments shown in FIG. 3 may include at least one of the processor 110, the transceiver 120 and the memory 130 of FIG. 1 or a combination thereof.

Referring to FIG. 3, the electronic apparatus according to example embodiments may include at least one of a catalog collection part 301, a data configuration part 303, a feed generation part 305, and a feed creation part 306.

The catalog collection part 301 collects catalog information (source information, snapshot information) according to example embodiments. The catalog information may include, for example, the source information according to example embodiments described with reference to FIG. 2. The catalog information according to example embodiments may be referred to as source information and snapshot information below. The source information may include, for example, item identification information for identifying the item, vendor identification information for identifying an entity that supplies or sells the item, and the like. Also, the catalog information according to example embodiments may include information on an item included in a page related to the item provided by the electronic apparatus. It may include an item name, item price, detailed option information about the item, installation schedule information when the item is an installation item, and URL information for the page corresponding to the item. In an example embodiment, as for the URL information for the page corresponding to the item, when feed information on an item is provided to a publisher and then a user selects the item from the external publisher based on the feed information, it can be linked to the page for the item based on the URL information. Such a URL may be referred to as a landing URL, and a user may be provided with a page for the corresponding item through an advertisement posted on an external publisher through the landing URL. When entering a service related to an electronic apparatus through the landing URL, the electronic apparatus may determine for which item a page is requested based on a parameter included in the corresponding URL, and provide the user with a corresponding page.

The catalog collection part 201 may periodically receive information on the item for each item, and may check the updated information on the item for each item. The information on the item may be collected, for example, from the CDS. In an example embodiment, when the catalog information of some items is newly created or updated, only the catalog information of the corresponding item may be separately received as well as the periodic check described above. The catalog information according to example embodiments may be referred to as source information and snapshot information below.

The electronic apparatus 300 according to example embodiments may further include a search engine part 302 for storing the source information (snapshot information) according to example embodiments and providing a search function for the stored source information. The catalog collection part 301 collects the source information, and may provide and store the collected source information to the search engine part 302. The electronic apparatus 300 according to example embodiments may collect the catalog information based on an application programming interface (API) for collecting the source information provided by the CDS and the like and store it in the search engine part 302. The search engine part 302 according to example embodiments may include a search engine implemented as, for example, ElasticSearch. The search engine part 302 may be referred to as a first storage part below.

The source information according to example embodiments may be, for example, information for which bibliographic information on items is sporadically collected from the CDS. Accordingly, in order to generate an advertisement feed including necessary information to be provided to a publisher adaptively in real time, the electronic apparatus 300 according to example embodiments need to map or bundle the source information for each item to organize it into one or more data structures. Accordingly, the electronic apparatus according to example embodiments may include the data configuration part 303 for organizing the one or more data structures.

The data configuration part 303 inquires one or more source information (snapshot information) collected by the catalog collection part 301, and generates feed data for generating a feed based on the inquired source information. The feed data may refer to, for example, data for generating an advertisement feed generated by extracting, analyzing, and organizing meaningful data from the source information. The data configuration part 303 extracts meaningful data from the search engine part storing information on one or more items collected from the catalog collection part 301 to generate data for generating the advertisement feed. The data for generating the advertisement feed may be obtained through a data structure configured in the form of, for example, JavaScript Object Notation (JSON). The feed data configuration part 202 may generate data for generating the advertisement feed according to example embodiments and store it in a storage part (e.g., a database part).

The data configuration part 303 may check the collected source information on the item from the catalog collection part 301. The data configuration part 303 may, for example, check the source information from the catalog collection part 301, or may check the source information from the search engine part 302 according to example embodiments. The data configuration part 303 may generate feed data for configuring an advertisement feed of the item by checking the source information and processing and transforming them. The feed data may construct a data structure for generating an advertisement feed for each item by organizing and processing the information on the item collected and stored in, for example, the catalog collection part 301 or the search engine part 302 according to specific criteria. The data configuration part 303 may store the generated data for generating the advertisement feed according to example embodiments in the data storage part 304. The data storage part 304 may be, for example, a storage included in the electronic apparatus 300 according to example embodiments or a storage implemented as a database (e.g., a storage part in which MySQL is embedded). The data storage part 304 may be referred to as a second storage part below.

The data storage part 304 according to example embodiments may exist, for example, outside of the electronic apparatus 300 according to example embodiments instead of inside thereof, and the data storage part 304 may include a storage provided by an external server (e.g., a storage built in a distributed server). That is, the data configuration part 303 may transmit the data for generating the advertisement feed and a request for storage to the external server in order to store the generated data for generating the advertisement feed in the data storage part 304 of the external server.

The data storage part 304 according to example embodiments updates the data for generating the advertisement feed as soon as the information (source information) on the item is collected by the catalog collection part 301 to update or store in the data storage part 304.

The feed generation part 305 may include the feed generation part 201 of FIG. 2. The feed generation part 305 generates the advertisement feed for advertisement of the item by using the data for generating the advertisement feed generated by the data configuration part 303. The feed generation part 305 may receive the data for generating the advertisement feed from the data configuration part 303, or it may request or inquire the data for generating the advertisement feed for the corresponding item to the data storage part 304 according to example embodiments and generate data for generating the advertisement feed for the item in order to generate the advertisement feed of the item. The feed generation part 305 may generate the advertisement feed of the item by using the data for generating the advertisement feed, and store the generated advertisement feed in the feed storage part 307 according to example embodiments. The feed storage part 307 may be, for example, a storage included in the electronic apparatus 300 according to example embodiments or a storage implemented as a database (e.g., a storage in which MySQL is embedded). The feed storage part 307 may be referred to as a third storage part below.

The feed storage part 307 according to example embodiments may exist, for example, outside of the electronic apparatus 300 according to example embodiments instead of inside thereof, and the data storage part 304 may be a storage provided by an external server (e.g., a web storage service embedded in a distributed server) (e.g., S3 web storage service provided by Amazon, etc.). That is, the feed storage part 307 may transmit the advertisement feed information and a request for storing the advertisement feed information to the external server to store the generated advertisement feed information in the feed storage part 307 of the external server. The feed storage part 307 according to example embodiments may update or store the advertisement feed information on the item generated by the feed generation part 305 as soon as it is collected.

The electronic apparatus 300 according to example embodiments may include one feed generation part 305 or a plurality of feed generation parts 305 separately for each item. For example, when ten items are managed by the electronic apparatus 300 to generate the advertisement feed, the electronic apparatus 300 may include ten feed generation parts 305.

The feed creation part 306 may include the feed creation part 203 of FIG. 2. The feed creation part 306 may receive the advertisement feed information of the item from the feed generation part 305 in order to process the advertisement feed according to the format of the publisher 309 and provide the publisher with the advertisement feed. The feed creation part 306 may inquire and extract the advertisement feed information from the feed storage part 307 in order to process the advertisement feed according to the format of the publisher 309 and provide the publisher with the advertisement feed. For example, when the feed storage part 307 is a storage included in the electronic apparatus 300, the feed creation part 306 may extract the advertisement feed information from the feed storage part 307. For example, when the feed storage part 307 is an external storage (e.g., an S3 service provided by Amazon Web Service) that exists other than the electronic apparatus 300, the feed creation part 306 may transmit request information to the external storage in order to extract the advertisement feed information from the feed storage part 307.

The feed creation part 306 according to example embodiments may process the advertisement feed information on the item. The feed creation part 306 according to example embodiments may provide the publisher with the advertisement feed information.

The feed creation part 306 may upload (or update) to the feed storage part 307 according to example embodiments in order to provide the advertisement feed information to the publisher. In this case, in response to receiving a syndication request from the publisher, the electronic apparatus 307 according to example embodiments transmits the advertisement feed information on the item stored or updated in the feed storage part 307 to the server of the publisher.

The feed creation part 306 may upload (or update) to the external storage 309a in order to provide the publisher with the advertisement feed information. In this case, the external storage 309a transmits the advertisement feed information on the item stored or updated in the feed storage part 307 to the server of the publisher in response to receiving a syndication request from the publisher. The external storage 309a may be a storage included in a server through which the publisher transmits the syndication request, and the external storage 309a may be, for example, a storage provided by a web storage service provided by an external server (e.g., S3 service provided by Amazon, etc.). The external storage 309a may be referred to as a fourth storage part below.

A syndication request and a response thereto according to example embodiments may be performed based on a syndication API.

The electronic apparatus 300 according to example embodiments may further include a syndication setting part 308. The syndication setting part 308 may set parameters (setting information) describing a method of generating and processing when the feed creation part 306 or the feed generation part 305 generates and processes the advertisement feed information of the item. That is, the syndication setting part 308 may include a design tool provided to an administrator to create and set information indicating a method or policy for processing the advertisement feed to provide to each publisher 309.

The syndication setting part 308 may include, for example, the setting information acquisition part 202 of FIG. 2.

The syndication setting part 308 may set, for example, a method of generating the advertisement feed information for each publisher 309 in order to provide a customized advertisement feed for each publisher 309 and additional information to be included in the advertisement feed information. The syndication setting part 308 may set a method for generating the advertisement feed information and the additional information to be included in the advertisement feed information based on an input signal of an administrator, and may apply the method for generating the advertisement feed information and the additional information to be included in the advertisement feed information that have been set to the feed generation part 305 or the feed creation part 306 according to example embodiments. That is, the syndication setting part 308 may be a configuration in which the administrator can set conditions to be additionally set in order to be syndicated by the publisher.

The syndication setting part 308 may be included in the electronic apparatus 300 according to example embodiments, or may be built in a server external to the electronic apparatus 300.

The electronic apparatus 300 according to example embodiments may include one feed creation part 306 or a plurality of feed creation parts 306 separately for each item. For example, when ten items are managed by the electronic apparatus 300 to generate the advertisement feed, the electronic apparatus 300 may include ten feed creation parts 306. Each feed creation part 306 may receive the advertisement feed information from the feed generation part 305 for the item corresponding to each feed creation part 306.

The electronic apparatus according to example embodiments includes and uses separate storage parts in the process of collecting information on the item, configuring data, generating a feed, and processing the feed to update information on the item and provide the feed, thereby simplifying the procedure of providing the advertisement feed for the item to the publisher and reducing unnecessary delay and memory burden.

In addition, the electronic apparatus according to example embodiments continuously receives and updates the information on the item and, at the same time, provides the advertisement feed information to the publisher at regular intervals to transmit the updated information on the item in the advertisement feed without unnecessary delay.

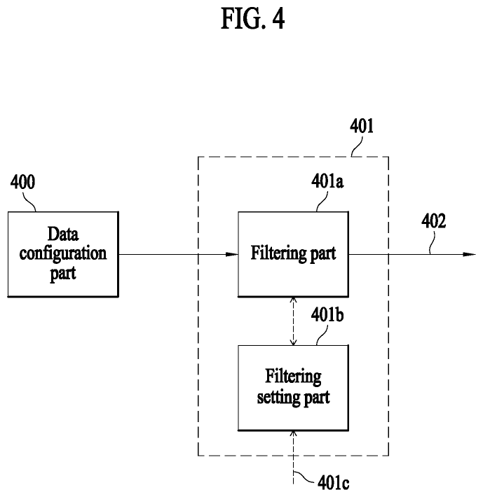

FIG. 4 is a diagram illustrating an example of a method for a feed management apparatus to filter items according to example embodiments.

Specifically, FIG. 4 shows some of the components included in the feed management apparatus (electronic apparatus) according to example embodiments. Referring to FIG. 4, the electronic apparatus according to example embodiments may include at least one of a data configuration part 400, a filtering part 401a, and a filtering setting part 401b. According to example embodiments, the filtering part and the filtering setting part 401 may be included in the feed generation part (e.g., configuration 201 of FIG. 2 or configuration 305 of FIG. 3). The data configuration part 400 may include the data configuration part 303 shown in FIG. 3.

The filtering part 401a and the filtering setting part 401b according to example embodiments may be included as a part of the data configuration part 400. That is, the electronic apparatus according to example embodiments may filter specific item(s) upon receiving information on items (source information).

Referring to FIG. 4, the filtering part 401a according to example embodiments classifies the item(s) according to example embodiments according to the policy and filters the item(s) corresponding to the specific policy to apply the corresponding setting information. The policy according to example embodiments may refer to a criterion by which the electronic apparatus according to example embodiments selects one or more specific item(s) from a plurality of items. That is, the filtering part 401a may filter items (targets) to be advertised according to the policy before generating an advertisement feed of the item to be provided to the publisher. The filtering part 401a may filter a plurality of items based on one or more filtering conditions related to the policy.

For example, in some cases, the electronic apparatus may not advertise a high-priced item in a shopping mall provided by a specific publisher (first policy). Accordingly, the filtering part 401a according to example embodiments may filter items of a specific amount of price or more. In this case, the filtering condition may be ‘the price of the item must be below (or higher than) a specific price’ or ‘the price of the item must be within (out of) a specific price’. For example, in some cases, the electronic apparatus may decide not to advertise items of a specific vendor in a shopping mall provided by a specific publisher (second policy). Accordingly, the filtering part 401a according to example embodiments may filter items of a specific vendor as an advertisement exclusion target. In this case, the filtering condition may be ‘the item's vendor is not the xxx vendor (or the item's vendor is xxx’). For example, in some cases, in a shopping mall provided by a specific publisher, etc., the electronic apparatus may advertise or decide not to advertise an item with a price (e.g., a medium price, a high price, etc.) within a specific range (third policy). Accordingly, the filtering part 401a according to example embodiments may filter items having a price within a specific range as an advertisement exclusion target or an advertisement target. In this case, the filtering condition may be ‘the price of the item must be within a specific range (or not within a specific range)’.

The policy according to example embodiments may consist of one filtering condition, or a plurality of filtering conditions may be combined by logical operation.

The filtering setting part 401b sets filtering condition(s) according to example embodiments to generate one or more policies by a user input or by an operation of a system. The filtering setting part 401b may generate one or more filtering condition(s) based on the administrator's input signal 401c, and may apply the generated filtering condition(s) to the filtering part 401a. The electronic apparatus according to example embodiments may provide a page including an interface for receiving the administrator's input signal 401c to a terminal apparatus of the administrator.

The electronic apparatus according to example embodiments filters the item (target) to be advertised before generating the advertisement feed of the item to be provided to the publisher based on filtering conditions, thereby helping the administrator to create a customized advertisement feed. That is, the electronic apparatus may help to make an advertisement that suits the taste of the administrator based on such an operation.

For example, filtering conditions according to example embodiments may be configured as shown in the following table. L1 and L2 may indicate, for example, a hierarchical structure of filtering conditions.

TABLE 1

| Filters | | |
|---|---|---|
| L1 filtering | L2 filtering | |
| condition | condition | Descriptions |
| Common | IsAdult attribute | Filter item(s) that are only allowed to |
| | of items | be sold to people over a certain age |
| | | or adults |
| | Product (ID based | Exclude item(s) with item ID |
| | blacklist) | corresponding to blacklist |
| | Category (ID based | Exclude item(s) with category ID |
| | blacklist) | corresponding to blacklist |
| | Vendor (Buybox | Exclude item(s) of vendors |
| | vendor blacklist) | corresponding to blacklist |
| | Vendor (ID based | Exclude item(s) of vendors |
| | blacklist) | corresponding to blacklist |
| | Keyword (Product | Exclude item(s) related to specific |
| | title & search tag) | keyword (item title, search tag, etc.) |
| Additional | Division | Exclude item(s) handled by specific |
| | | sector, specific category, or specific |
| | | department |
| | Price | Exclude or include item(s) above or |
| | | below a certain price |
| | Seller Score (excluding | Exclude item(s) with seller's score |
| | RED score) | below a certain score |
| | CPI (Competitive | Filter items whose Competitive Price |
| | Price Index) | Index (CPI) is below or above a |
| | | certain value |

The filtering conditions shown in Table 1 may be combined by AND or OR operation of the respective conditions.

The filtering conditions shown in Table 1 may be applied differently for each publisher. Referring to Table 1, among the filtering conditions shown in Table 1, the filtering conditions corresponding to the Common row of L1 may mean, for example, filtering conditions commonly required (or supported) by a specific publisher.

When the advertisement information on the item is provided to the external publisher, the electronic apparatus according to example embodiments uses a filter corresponding to the publisher for necessary information among the information of the item in a service operated by the electronic apparatus to create a feed according to the characteristics of the publisher. Therefore, it is possible to adaptively perform advertisements according to the characteristics of the publisher, thereby increasing the advertisement effect and effectively managing the information on the item provided in the advertisements.

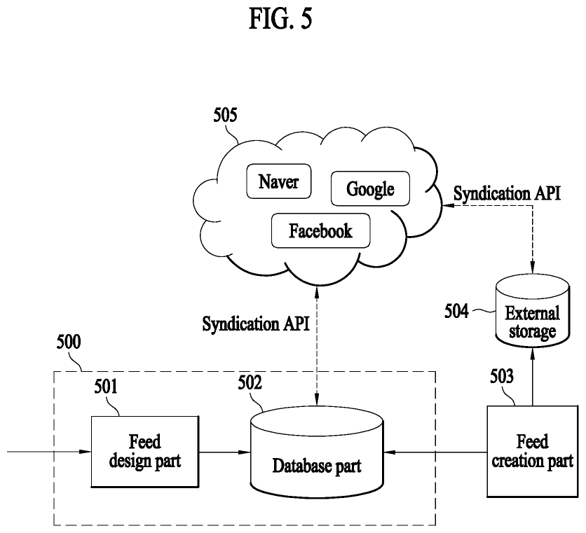

FIG. 5 is a diagram illustrating an example of a method for a feed management apparatus according to example embodiments to provide an advertisement feed to a publisher by generating or processing the advertisement feed.

Specifically, FIG. 5 shows some of the components included in the feed management apparatus (electronic apparatus) according to example embodiments. Referring to FIG. 5, the electronic apparatus according to example embodiments may include at least one of a feed design part 501, a database part 502, a feed creation part 503, and an external storage 504. According to example embodiments, the feed design part 501 and the database part 502 may be included in the feed generation part (e.g., configurations 201 to 202 of FIG. 2, configuration 305 of FIG. 3, configuration 401 of FIG. 4, etc.). The feed creation part 503 may include the feed creation part 203 or the data configuration part 303 shown in FIG. 3.

The feed design part 501 may set parameters (setting information) necessary for the electronic apparatus according to example embodiments to generate an advertisement feed for an item based on information about the item or may set or generate a policy for generating the advertisement feed. The feed design part 501 may receive, for example, input signals from users, and may generate or modify advertisement feed information based on the input signals. The input signals that the feed design part 501 receives from administrators according to example embodiments may include, for example, information to be included in the advertisement feed among the information on items, an arrangement and placement order of information to be included in the advertisement feed, information indicating a form of displaying information included in the advertisement feed (e.g., the title of the item, name of the item, price of the item, etc.) included in the advertisement feed, and so on.

The feed design part 501 according to example embodiments may provide administrators with a tool for generating (or producing) an advertisement feed. The feed design part 501 may provide, for example, a design tool or a user interface for administrators to design an advertisement feed to be provided to each publisher. The feed design part 501 according to example embodiments may provide a tool that allows an administrator to adaptively design an advertisement feed for each item.

The feed design part 501 according to example embodiments may be embedded in, for example, the syndication setting part 308 of FIG. 3. In addition, the feed design part 501 may be included in the feed generation part 305, or may be included in the electronic apparatus 300 as a separate component from the syndication setting part 308 and the feed generation part 305.

Referring to FIG. 5, the database part 502 according to example embodiments may store an advertisement feed for at least one item generated by the electronic apparatus. The database part 502 may represent, for example, the feed storage part 307 (or the third storage part) of FIG. 3. For example, the electronic apparatus according to example embodiments may store the advertisement feed for at least one item generated by the feed generation part in the database part 502. The electronic apparatus according to example embodiments periodically receives the information on the item (e.g., source information), and the data configuration part periodically generates data for generating the advertisement feed for each item based on the received source information. The feed generation part may periodically generate or update the advertisement feed information for each item based on the data for generating the advertisement feed, and may store them in the database part 502.

Meanwhile, the feed creation part 503 may transmit the advertisement feed for at least one item to the publisher 505 according to example embodiments periodically or in response to a request of the publisher 505. Accordingly, the feed creation part 503 may periodically or in response to a request of the publisher 505 check the advertisement feed for the item from the database part 502 and process it according to the format of the publisher 505. The feed creation part 503 may re-insert or update the processed advertisement feed into the database part 502, or may upload it to the external storage 504. The external storage 504 may refer to, for example, the external storage 309a of FIG. 3.

The database part 502 according to example embodiments may provide the publisher 505 with the advertisement feed updated by the feed creation part 503 periodically or in response to a request of the publisher 505 according to the syndication API of the publisher 505. The external storage 504 according to example embodiments may provide the publisher 505 with the advertisement feed updated by the feed creation part 503 periodically or in response to a request of the publisher 505 according to the syndication API of the publisher 505.

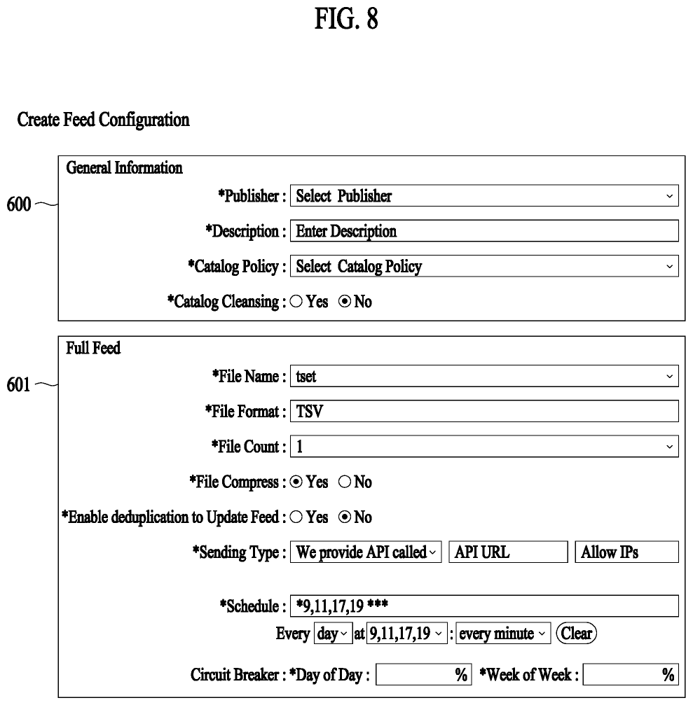

Referring to FIG. 5, the database part 502 according to example embodiments may store the information for generating the advertisement feed set by the feed design part 501 (e.g., the above-described policy, setting information required to generate the feed). An example of a setting tool provided to administrators by the feed design part 501 to generate the advertisement feed will be described with reference to FIGS. 8 to 10. Examples of the information for generating the advertisement feed are described with reference to FIGS. 6 to 7.

The electronic apparatus according to example embodiments updates information on the item and provides the feed by using a separate storage in the process of collecting the information on the item, configuring data, generating the feed, and processing the feed, thereby simplifying the process of providing the publisher with the advertisement feed for the item and reducing unnecessary delay and memory burden.

The electronic apparatus according to example embodiments continuously receives and updates the information on the item and, at the same time, provides advertisement feed information to the publisher at regular intervals to include and transmit the updated information on the item in the advertisement feed without unnecessary delay.

FIG. 6 shows an example of setting information related to an advertisement feed of an item according to example embodiments.

The parameters according to example embodiments shown in FIG. 6 may include information for generating the advertisement feed (setting information) described with reference to FIG. 5. The setting information of the item according to example embodiments shown in FIG. 6 may include information indicating a method or policy of processing the advertisement feed to provide to each publisher 309 described in FIG. 3. That is, the setting information shown in FIG. 6 may be parameters set by an administrator or systematically in the syndication setting part 308 of FIG. 3 and the feed design part 501 of FIG. 5.

The setting information according to example embodiments may include at least one of: unique identification information (id) for the item; information indicating whether the item is in stock (availability); information indicating the condition of the item (e.g., new, refurbished, used, etc.) (condition); information describing the item (description); link information of an image of the item used in the advertisement (image_link); a link to an additional image of the item for the slide-show image type (additional_image_link); a link to the merchant's PC site where the item can be purchased (link); a link to the merchant's mobile site where the item can be purchased (mobile_link); information indicating the title of the item (title); information indicating a price and currency of the item (price); information indicating a discounted price (sale_price); information indicating shipping cost (shipping); codes specified by international standards for identifying products or publishers (e.g., gtin, mpn, brand, etc.); information related to the product classification prescribed by each publisher (for example, information indicating predefined values of Google's product taxonomy is google_product_category, and the value may be, for example, Apparel & Accessories>Clothing>Dresses); the item's internal category information (product_type); parameters related to consumers' operating systems (e.g., ios_url, ios_app_store_id, ios_app_name, android_url, android_package, android_app_name, etc.); information set to True for the case of an adult item, otherwise False (adult); information indicating an actual price of the item (actual price); and information on a landing address to move to the page to purchase the item (link_new). Values of the information (respective parameters) shown in FIG. 6 may be set by a tool provided to an administrator, and each parameter may be separately set for each item or publisher.

The unique identification information for a corresponding item according to example embodiments may be set in various ways for each item. If there are multiple instances of the same ID, all instances may be ignored. The information indicating whether the item is in stock (availability) may be expressed as a first value indicating that it is in stock, a second value indicating that it is not in stock, a third value indicating that it is not currently in stock but will be in stock within a certain period of time, or the like. The link information (image_link) of the image of the item used in the corresponding advertisement may be a square 1:1 aspect ratio image. For example, a single product ad may be an image with 1.91:1 ratio. The information indicating the price and currency of the item (price), information indicating shipping cost (shipping), and information indicating the discounted price (sale_price) may be, for example, string values written in conformity with the currency standard codes of ISO4217 (for example, “9.99 USD”).

FIGS. 7A and 7B show examples of setting information related to an advertisement feed of an item according to example embodiments.

Specifically, parameters related to an advertisement feed of an item according to example embodiments shown in FIGS. 7A and 7B may be parameters applied to the feed creation part 204 of FIG. 2, the feed creation part 306 of FIG. 3, and the feed creation part 503 of FIG. 5. That is, the parameters shown in FIGS. 7A and 7B represent parameters applied to the feed creation part according to example embodiments among the setting information of the item including the parameters shown in FIG. 6. The parameters related to the advertisement feed of the item according to example embodiments shown in FIGS. 7A and 7B may include information indicating a method or policy of processing the advertisement feed to provide to each publisher 309 described with reference to FIG. 3. That is, the advertisement feed-related parameters shown in FIGS. 7A and 7B may be parameters set by an administrator or systematically in the syndication setting part 308 of FIG. 3. The parameters shown in FIGS. 7A and 7B (i.e., parameters applied to the feed creation part) may be referred to as setting information. The setting information may be set differently for each publisher or for each item (or item category).

The setting information according to example embodiments may include advertisement feed identification information for identifying an advertisement feed (feed_id), information indicating a title of the advertisement feed (title), information indicating a price of an item appearing in the advertisement feed (original_price), information indicating a discounted price of the item appearing in the advertisement feed (sale_price), landing address information to move from the advertisement feed to a page selling the item (e.g., item detail page, etc.) (landing_url), application link information of the item applied to the advertisement feed (app_link).

The feed identification information (feed_id) according to example embodiments may include information indicating a feed identification policy (feed_id_policy). The information indicating the feed identification policy may include, for example, a feed level. The feed level indicates whether the corresponding advertisement feed is applied to each specific item, whether the corresponding advertisement feed is applied in a group unit of a specific item, whether the corresponding advertisement feed is applied to each specific vendor, or whether it is applied in common to all items.

The information indicating the title of the advertisement feed (title) according to example embodiments may include a first detailed parameter indicating the phrase of the title of the item (e.g., add_prefix_with_vendor_flex, add_prefix_with_used_goods, add_prefix_with_oversea_purchased) and a second detailed parameter indicating the maximum display length of the title of the item (e.g., max_length). In an example embodiment, the phrase may be in the form of a prefix added to the front of the title, and such a phrase may be determined based on the item information and publisher information. By adding such a phrase, the publisher may perform advertisement using a title of a different format from the title of the item in the service provided by the electronic apparatus.

In other words, the setting information according to example embodiments may include first information for processing the title information of the advertisement feed included in the source information. The electronic apparatus (or the feed creation part, or the feed generation part) according to example embodiments processes the title information according to example embodiments based on the first information to generate advertisement feed information of the corresponding item to provide to a specific publisher (or all publishers). The first information according to example embodiments may include prefix information indicating a prefix added to the title information.

The information indicating the price of the item appearing in the advertisement feed (original price) may include detailed parameters (e.g., use_price_band_with_3p and format parameters) indicating a method of expressing the price. Information indicating the discounted price of the item appearing in the advertisement feed (sale_price) may include detailed parameters indicating a method of expressing the price (e.g., use_price_band and format) and detailed parameters indicating a policy for determining the discounted price (e.g., sale_price_policy).

In other words, the setting information according to example embodiments may include second information indicating a method of displaying price information of the advertisement feed included in the source information. The electronic apparatus (or the feed creation part, or the feed generation part) according to example embodiments processes the price information according to example embodiments based on the second information according to the above-described method of expressing the price information, so that advertisement feed information of the corresponding item to provide to a specific publisher (or all publishers) may be generated.

The landing address information (landing_url) according to example embodiments may include a base URL (Uniform Resource Locator), item identification information for identifying the corresponding item, and vendor identification information for identifying a vendor of the item. The item identification information and vendor identification information included in the landing address information (landing_url) may be the source information on the item or information included in data for generating the advertisement feed.

That is, the electronic apparatus according to example embodiments extracts the item identification information and vendor identification information from the source information or the data for generating the advertisement feed, generates a landing address to be applied to the advertisement feed of the corresponding item, and may store it as the value of the landing address information. The item identification information and vendor identification information of the landing address information according to example embodiments may be included in a query string following the base URL (Uniform Resource Locator).

The electronic apparatus according to example embodiments may differently generate the landing address information (landing_url) according to example embodiments for each publisher and according to an operating system or driving platform of a client.

For example, the landing address information (landing_url) according to example embodiments may be stored in the form of a template. The electronic apparatus may check the driving platform and operating system information of the client from the client, and may generate the landing address information based on the checked driving platform and operating system information. The driving platform may include, for example, a PC web or a mobile web, and the operating system may include Android and iOS.

The landing address information (landing_url) according to example embodiments may be stored in the form of a template configured to generate the landing address information in the completed form based on the operation of the string as shown in Table 2 below.

TABLE 2

| Lan- ding | First publisher | Second publisher | |
|---|---|---|---|
| URL | Template | Template | . . . |
| PC | N/A | http://landing.coupang.com/m | |
| Web | | ulti?sid=BAND_a&src=10120 | |
| | | 15&spec=10506208&addtag= | |
| | | 400&ctag= + product id + | |
| | | “&pt=PRODUCT&pld=” + | |
| | | product id + | |
| | | “&forceBypass=Y” | |
| Mo- | “http://landing.coupang.com/ | http://landing.coupang.com/m | |
| bile | m/multi?sid=FB_DY&src=10 | ulti?sid=BAND_a&src=10190 | |
| Web | 11037&spec=10606220&lpt | 15&spec=10506208&addtag= | |
| | ag=FB_DY&addtag=400&ct | 400&ctag= + product id + | |
| | ag=”+product | “&pt=PRODUCT&pld=” + | |
| | id+“&product=”+product | product id + | |
| | id+“&forceBypass=Y” | “&forceBypass=Y” | |
| An- | “coupang://product?pld=”+p | http://landing.coupang.com/m | |
| droid | roduct | ulti?sid=BAND_a&src=10190 | |
| | id&src=srccode&spec=spec | 15&spec=10506208&addtag= | |
| | code | 400&ctag= + product id + | |
| | | “&pt=PRODUCT&pld=” + | |
| | | product id | |
| iOS | “coupang ://product?pld=”+p | http://landing.coupang.com/m | |
| | roduct | ulti?sid=BAND_a&src=10190 | |
| | id&src=srccode&spec=spec | 15&spec=10506208&addtag= | |
| | code | 400&ctag= + product id + | |
| | | “&pt=PRODUCT&pld=” + | |
| | | product id + | |
| | | “&forceBypass=Y” | |

The item identification information and vendor identification information may be included in, for example, the setting information according to example embodiments. For example, the setting information according to example embodiments may include the item identification information for each publisher (e.g., naver_product_id, etc.) and may include the vendor identification information (e.g., vendor_id).

The setting information according to example embodiments may include item description information to be applied to the advertisement feed. The item description information may be set differently for each publisher. For example, the item description information displayed in the advertisement feed syndicated to Google may be set in a google_description parameter.

The setting information according to example embodiments may include parameters indicating a category of one or more items (fifth information indicating a category). The parameters indicating the item category may include, for example, information indicating the category of the item (category_name, category_id), information indicating the category of the item according to the category classification standard provided by a specific publisher (e.g., naver_category_name, coupang_category_id, coupang_category_name, google_product_category).

The setting information according to example embodiments may include information indicating a source (brand, trademark) of the item (brand). The information indicating the source of the item (brand) may include, for example, a detailed parameter (max_length) indicating the maximum length of the brand of the item.

The setting information according to example embodiments may include information indicating a shipping cost of the item (shipping_price) and information indicating a shipping method of the item (shipping_settings).

The setting information according to example embodiments may further include search tag information (search_tag) (sixth information indicating a search tag) for enabling the corresponding item to be searched by a search engine of a publisher. The search tag information may include, for example, a detailed parameter indicating the maximum length of a search tag (max_length) and a detailed parameter indicating the maximum number of search tags (max_tag_count).

The setting information according to example embodiments may include information indicating the number of views of the detailed page of the corresponding item (review_count), information related to card benefits applied to the corresponding item (e.g., card name (card_name), payment amount (card_price) when paying by card, and card event (card_event)), and time information (update_time) at which the item is updated.

The setting information according to example embodiments may include third information indicating a period of time in which the feed information generated by the feed generation part or feed creation part is provided to each publisher. The electronic apparatus according to example embodiments may provide the advertisement feed information of the item to at least one publisher for each period indicated in the above-described third information. Meanwhile, in some embodiments, the third information may be set to a value corresponding to the publisher, and may include time information rather than a specific period. For example, the first publisher and the second publisher may be provided with feeds at different times, and thus, by making the feed provision times different, the operating load of the electronic apparatus may be reduced.

The setting information according to example embodiments may further include information indicating the origin of the item. The information indicating the origin of the item may be, for example, an ISO country code as its value.

The setting information according to example embodiments may further include the maximum number of purchasers (buy_max) of the corresponding item, the number of purchasers of the corresponding item (buy_count), information indicating conditions for free shipping (free_shipping), the type of delivery (e.g., fast delivery, reserved delivery, etc.) (type_shipping), information indicating a representative image of the item, and information indicating a ranking of the evaluation of the item.

The setting information according to example embodiments may further include information indicating a file format of a file including feed information for a plurality of items requested by a publisher.

The setting information according to example embodiments may further include additional setting information for a specific publisher. For example, with respect to a publisher providing a price comparison service among publishers, information related to price comparison (e.g., identification information of an item of which price to be compared with, etc.) and information related to purchase conditions of the item may be included.

Also, the setting information according to example embodiments may further include information representing event words included in the advertisement feed provided to a specific publisher. For example, the information representing event words may include phrases to be included in the advertisement feed of a particular publisher (e.g., “Order today, rocket delivery will arrive tomorrow/Rocket Wow customers earn up to 3% cash/Rocket Wow 30 days free trial”, etc.).

By setting parameters for configuring the advertisement feed, the electronic apparatus according to example embodiments may automatically update the information on the item based on the set parameters, thereby reducing system delay and assisting the administrator to create a customized advertisement feed.

FIG. 8 illustrates an example of a first page for setting, by an electronic apparatus according to example embodiments, setting information in order to configure an advertisement feed of an item.

Specifically, FIG. 8 illustrates a page for setting a feed configuration provided to an administrator by the electronic apparatus according to example embodiments, and illustrates the first page for the administrator to set the setting information shown in FIGS. 6 to 7. The first page may be generated by, for example, the syndication setting part 308 of FIG. 3 and the feed design part 501 of FIG. 5 and provided to the administrator.

The first page according to example embodiments may include at least one of a first area 600 for setting bibliographic details of the advertisement feed of the item and a second area 601 for setting details of the advertisement feed of the item.

The first area 600 may include an interface for setting a publisher who wants to provide (or syndicate) the advertisement feed of the item, an interface for setting information describing the advertisement feed of the item, an interface for setting an item policy (catalog policy), and an interface for setting whether to cleansing the catalog of items may be included.

The second area 601 may include an interface for setting a name of a file including the advertisement feed of the item, an interface for setting a format of the file including the advertisement feed of the item, an interface for setting the number of files including the advertisement feed of the item, an interface for setting whether to compress the file including the advertisement feed of the item, an interface for setting how to send (or syndicate) the advertisement feed of the item, an interface for setting a period and time of sending (or syndicating) the advertisement feed of the item, and an interface for setting a condition and time for stopping sending (or syndicating) the advertisement feed of the item.

The interface for setting how to send (or syndicate) the advertisement feed of the item may include, for example, an interface for determining whether to provide advertisement feed information to a publisher using a syndicate API provided by the publisher or to provide the advertisement feed information to the publisher using the API embedded in the electronic apparatus according to example embodiments.

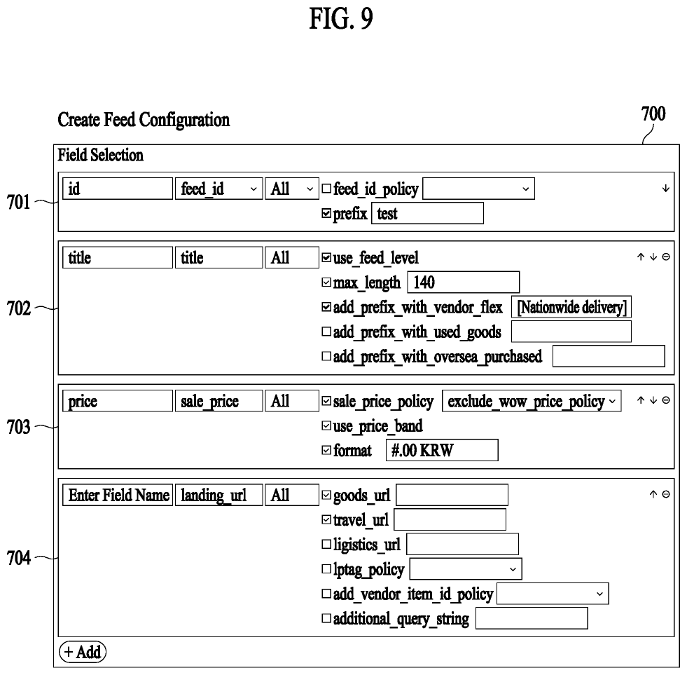

FIG. 9 illustrates an example of a first page for setting, by an electronic apparatus according to example embodiments, setting information in order to configure an advertisement feed of an item.

Specifically, FIG. 9 illustrates a page for setting a feed configuration (for example, setting information shown in FIGS. 6 to 7) provided to an administrator by the electronic apparatus according to example embodiments, and illustrates the first page for the administrator to set the setting information according to example embodiments shown in FIGS. 6 to 7. The first page may be generated by, for example, the syndication setting part 308 of FIG. 3 and the feed design part 501 of FIG. 5 and provided to the administrator. The first page may include, for example, the first page described with reference to FIG. 8, and the first page shown in FIG. 9 may include at least one of the first area 600 and the second area 601 of FIG. 8.

The first page according to example embodiments may include a third area 700 for setting values of setting information according to example embodiments. The third area 700 according to example embodiments may include at least one interface for inputting parameters of setting information to be set.

The third area 700 according to example embodiments may include interfaces for setting each parameter of the setting information.

The third area 700 according to example embodiments may include a first setting area 701 for setting a value of identification information (feed_id) of the advertisement feed among parameters of setting information. That is, the first setting area 701 may include an interface for changing or setting the feed_id parameter of FIGS. 6 to 7. The first setting area 701 according to example embodiments may include at least one interface for setting a feed level according to example embodiments.

The third area 700 according to example embodiments may include a second setting area 702 for setting a title of the advertisement feed among parameters of setting information. The second setting area 702 may include detailed interfaces for setting a phrase to be included in the title of the item according to the delivery type of the item or the category of the item, for example. For example, if the item is an item that can be shipped nationwide, a check box for marking a detailed parameter indicating that nationwide delivery is available and a string input box for setting a phrase to be included in the feed title for the item that can be shipped nationwide may be included. For example, if the corresponding item is a used item, a check box for marking a detailed parameter indicating that the item is a used item and a string input box for setting a phrase to be included in the feed title in the case of a used item may be included. That is, the second setting area 702 may be an area for changing or setting the title parameter of FIGS. 6 to 7.

The second setting area 702 may include detailed interfaces for setting a phrase to be included in the title of the item according to the delivery type of the item or the category of the item, for example. For example, if the item is an item that can be shipped nationwide, a check box for marking a detailed parameter indicating that nationwide delivery is available and a string input box for setting a phrase to be included in the feed title for the item that can be shipped nationwide may be included. For example, if the corresponding item is a used item, a check box for marking a detailed parameter indicating that the item is a used item and a string input box for setting a phrase to be included in the feed title in the case of a used item may be included. In the case of a used item, the phrase to be included in the feed title may be set to a value of add_prefix_with_used_goods of FIGS. 6 to 7. For example, if the item is an item that includes a service that provides installation by visiting a buyer's site, a check box for marking a detailed parameter indicating that the item is such an item and a string input box for setting a phrase to be included in the feed title in the case of such an item. In the case of such an item, the phrase to be included in the feed title may be set to a value of add_prefix_with_vendor_flex of FIGS. 6 to 7. For example, if the corresponding item is an overseas direct purchase item, a check box for marking a detailed parameter indicating that the item is such an item and a string input box for setting a phrase to be included in the feed title in the case of an overseas direct purchase item. In the case of an overseas direct purchase item, the phrase to be included in the feed title may be set to a value of add_prefix_with_oversea_purchased of FIGS. 6 to 7.

The third area 700 according to example embodiments may include a third setting area 703 for setting a price or a discounted price of the item appearing in the advertisement feed among parameters of setting information. The third setting area 703 may include detailed interfaces for setting the price or the discounted price of the item appearing in the advertisement feed. The third setting area 703 may include an interface for setting a sale price policy (sale_price_policy) for determining the discounted price and an interface for setting a unit for displaying the price or the discount price (e.g., 1,000 won unit, 10,000 won unit, 1 dollar unit, etc.) and a format (e.g., adding KRW to the end of the price, etc.). That is, the third setting area 702 may be an area for changing or setting at least one of parameters such as price, sale_price, or actual_price of FIGS. 6 to 7, and sub-parameters thereof.

The third area 700 according to example embodiments may include a fourth setting area 704 for setting an address of a landing page accessed by the advertisement feed. The address of the landing page according to example embodiments may refer to the landing address described with reference to FIGS. 6 to 8. Here, the fourth setting area 704 may include a detailed interface for selecting whether the item identification information and vendor identification information of the landing address information according to example embodiments are included in a query string following a base URL (Uniform Resource Locator).

The third area 700 according to example embodiments may include at least one of setting areas for setting parameters (setting information) shown in FIGS. 6 to 7 in addition to the first to fourth setting areas 701 to 704 shown in FIG. 9.

By setting the parameters of the setting information, the electronic apparatus according to example embodiments may automatically update the information on the item based on the set parameters, thereby reducing system delay and assisting the administrator to create a customized advertisement feed.

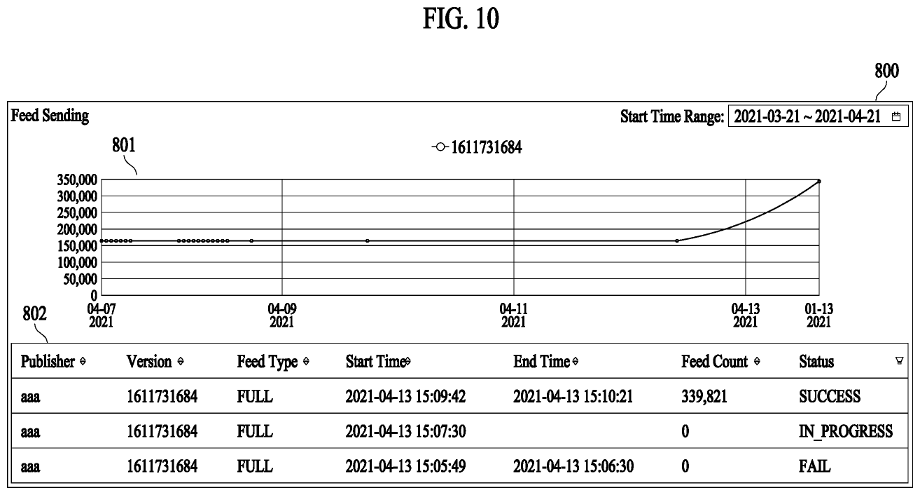

FIG. 10 illustrates a second page indicating a status in which an electronic apparatus according to example embodiments provides an advertisement feed of an item to a publisher.

Specifically, FIG. 10 illustrates a second page 800 indicating a status in which an electronic apparatus according to example embodiments provides a feed provided to each publisher. The second page 800 according to example embodiments may include a table 802 indicating information on advertisement feed configurations and statistical data 801 indicating a syndicate status of an advertisement feed.

The table 802 according to example embodiments indicates setting information according to example embodiments set by an administrator and information on the advertisement feed syndicated to the publisher. The table 802 according to example embodiments may include a column (Publisher) indicating a name of the publisher, a column (Version) indicating a version of the advertisement feed, a column (Feed Type) indicating a type of the advertisement feed, a column (Start Time) indicating the start time of syndicate (or sending) of the advertisement feed, a column (End Time) indicating the end time of syndicate (or sending) of the advertisement feed, a column (Feed Count) indicating the number of times the advertisement feed has been sent, and a column (Status) indicating whether the advertisement feed has been sent or is being sent successfully to the publisher.

The statistical data 801 according to example embodiments may include data indicating the number of advertisement feeds successfully sent by the electronic apparatus according to example embodiments to each publisher as a line graph, a bar chart, a pie chart, or the like.

According to the electronic apparatus according to example embodiments, an administrator can set information advertised through a feed (e.g., list price, discounted price, product name, blacklist of items, etc.) using such a UI, thereby increasing the advertising effect.

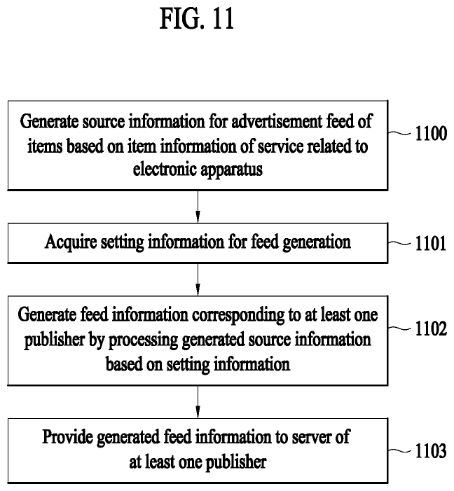

FIG. 11 shows an example of a method for managing item feed information of an item according to example embodiments.

The method for managing item feed information according to example embodiments shown in FIG. 11 may be performed by an electronic apparatus according to example embodiments. Some or all operations shown in FIG. 11 may be performed in the electronic apparatus according to example embodiments of FIGS. 1 to 10.

In order to solve the above problems, the method for managing item feed information according to example embodiments may include at least one of generating 1100 source information for an advertisement feed of items based on item information of a service related to the electronic apparatus, acquiring 1101 setting information for feed generation, generating 1102 feed information corresponding to at least one publisher by processing the generated source information based on the setting information, and providing 1103 the generated feed information to a server of the at least one publisher.

The setting information according to example embodiments may include first information for processing title information included in the source information, and the generating of the feed information may generate the feed information by processing the title information based on the first information.

The first information according to example embodiments may include prefix information indicating a prefix added to the title information.

The setting information according to example embodiments may include second information indicating a method of displaying price information included in the source information, and the generating of the feed information may generate the feed information by processing according to the method of displaying the price information based on the second information.

The setting information according to example embodiments includes third information indicating a period of time to provide the generated feed information to the publisher, and the providing to the server may provide the feed information to at least one publisher for each period.

The setting information according to example embodiments may include fourth information indicating a landing address of a page corresponding to an item accessible through the generated feed information. The fourth information according to example embodiments may include item identification information for identifying the item and vendor identification information for identifying a vendor for the item. Meanwhile, a page related to an item provided by the electronic apparatus may be accessed through advertisement information provided by the publisher based on the landing address. In an example embodiment, when a request corresponding to the landing address is received, the electronic apparatus may identify a corresponding item based on the landing address and provide a page corresponding to the identified item.

The setting information according to example embodiments may include fifth information indicating a category of the item and sixth information indicating a search tag for searching for the item.

Further, the setting information according to example embodiments may be set differently according to a policy for feed information applied to each item.

Furthermore, the generating of the feed information according to example embodiments may include checking the setting information corresponding to the policy applied to each item, and generating the feed information for the one or more items based on the setting information corresponding to the policy. Furthermore, the setting information may be set differently for each publisher.

The providing according to example embodiments may include uploading the generated feed information to an external server providing to the at least one publisher based on a syndication request of the at least one publisher.

In addition, the method for managing item feed information may further include storing the generated feed information, and the providing may provide the stored feed information to the at least one publisher based on a syndication request of the at least one publisher.

Further, the method for managing item feed information may further include providing a first page indicating a status of providing the feed information to the at least one publisher.

Furthermore, the setting information according to example embodiments may further include seventh information indicating a file format of the feed information.

When providing advertisement information about an item to an external publisher, the electronic apparatus according to example embodiments uses a filter corresponding to the publisher for necessary information among the information of the item in a service operated by the electronic apparatus to create a feed according to the characteristics of the publisher. Therefore, it is possible to adaptively perform advertisements according to the characteristics of the publisher, thereby increasing the advertisement effect, and effectively managing information on items provided in advertisements.

The electronic apparatus according to example embodiments updates information on the item and provides the feed by using a separate storage in the process of collecting the information on the item, configuring data, generating the feed, and processing the feed, thereby simplifying the process of providing the publisher with the advertisement feed for the item and reducing unnecessary delay and memory burden.

The electronic apparatus according to example embodiments continuously receives and updates the information on the item and, at the same time, provides advertisement feed information to the publisher at regular intervals to include and transmit the updated information on the item in the advertisement feed without unnecessary delay.

By setting the parameters of the setting information, the electronic apparatus according to example embodiments may automatically update the information on the item based on the set parameters, thereby reducing system delay and assisting the administrator to create a customized advertisement feed.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The electronic apparatus or terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

What is claimed is:

1. A method of managing, by an electronic apparatus, item advertisement feed information provided to a publisher, the method comprising:
generating source information for an advertisement feed of items based on item information of a service related to the electronic apparatus;
acquiring setting information for feed generation;
generating feed information corresponding to at least one publisher by processing the generated source information based on the setting information; and
providing the generated feed information to a server of the at least one publisher.

2. The method of claim 1, wherein the setting information includes first information for processing title information included in the source information, and
the generating of the feed information comprises generating the feed information by processing the title information based on the first information.

3. The method of claim 2, wherein the first information includes information on a phrase added to the title information,
the generating of the feed information comprises appending the phrase to the title information, and
the information on the phrase is determined based on the information on the item and the at least one publisher.

4. The method of claim 1, wherein the setting information includes second information indicating a method of displaying price information included in the source information, and
the generating of the feed information comprises processing the price information of the item based on the second information.

5. The method of claim 1, wherein the setting information includes third information indicating time information for providing the generated feed information to the publisher, and
the providing of the generated feed information to the server comprises providing the feed information to the at least one publisher based on the third information.

6. The method of claim 1, wherein the setting information includes fourth information indicating a landing address of a page corresponding to an item accessible through the generated feed information, and
the method further comprises providing a page corresponding to the item based on the landing address when a request corresponding to the landing address is received.

7. The method of claim 6, wherein the fourth information includes item identification information for identifying the item and vendor identification information for identifying a vendor for the item.

8. The method of claim 1, wherein the setting information further includes fifth information indicating a category of the item and sixth information indicating a search tag for searching for the item.

9. The method of claim 1, wherein the setting information is set differently according to a policy for feed information applied to each item.

10. The method of claim 9, wherein the generating of the feed information comprises:
checking the setting information corresponding to the policy applied to each item; and
generating the feed information for the one or more items based on the setting information corresponding to the policy.

11. The method of claim 5, wherein the setting information is set differently for each publisher.

12. The method of claim 1, wherein the providing comprising uploading the generated feed information to an external server providing to the at least one publisher based on a syndication request of the at least one publisher.

13. The method of claim 1, further comprising:
storing the generated feed information,
wherein the providing comprises providing the stored feed information to the at least one publisher based on a syndication request of the at least one publisher.

14. The method of claim 1, further comprising:
providing a page indicating a status of providing the feed information to the at least one publisher.

15. The method of claim 1, wherein the setting information further includes seventh information indicating a file format of the feed information.

16. The method of claim 6, wherein the fourth information is set differently for each operating system of a client.

17. An electronic apparatus comprising:
a feed generation part configured to generate source information for an advertisement feed of an item based on item information of a service related to the electronic apparatus;
a setting information acquisition part configured to acquire setting information for feed generation;
a feed creation part configured to process the generated source information based on the setting information to generate feed information corresponding to at least one publisher; and
a feed provision part configured to provide the generated feed information to a server of the at least one publisher.

18. A non-transitory computer-readable storage medium comprising:
a medium configured to store computer-readable instructions,
wherein when the computer-readable instructions are executed by a processor, the processor is configured to perform:
generating source information for an advertisement feed of items based on item information of a service related to the electronic apparatus;
acquiring setting information for feed generation;
generating feed information corresponding to at least one publisher by processing the generated source information based on the setting information; and
providing the generated feed information to a server of the at least one publisher.
